(19) United States
(12) Patent Application Publication
(10) Pub. No.: US 2009/0254608 A1
(43) Pub. Date: Oct. 8, 2009

(54) SERVICE COMMUNICATION LIST

(76) Inventors: David Butt, San Jose, CA (US); Scott Henning, Plano, TX (US); Richard Dunlap, Euless, TX (US); Clay Luther, Dallas, TX (US)

Correspondence Address: BRINKS HOFER GILSON & LIONE, P.O. BOX 10395, CHICAGO, IL, 60610, US

(21) Appl. No.: 12/099,677

(22) Filed: Apr. 8, 2008

(51) Int. Cl. G06F 15/16

(52) U.S. Cl. 709/203

(57) ABSTRACT

A system for aggregating communication events is provided. The communication system includes a communication device and a server. The server is operable to combine communication events from one or more services associated with the communication device into a communication events list. Each communication event is a past, present, or future communication event. The communication events list is transferred to and displayed on one or more communication devices.

### BACKGROUND

The present embodiments relate to aggregation of service communication event information for a service communication list.

A service communication list is a listing of service communication events. For example, the service communication list may include events for one or more services. The one or more services may be provided to one or more communication devices associated with the user.

### BRIEF DESCRIPTION OF THE DRAWINGS

FIG. 1 illustrates one embodiment of a communication system.

FIG. 2 illustrates one embodiment of a flowchart for displaying a service communication event list.

FIG. 3 illustrates one embodiment of a flowchart for distributing a service communication event list.

### DETAILED DESCRIPTION

The present embodiments relate to aggregation of service communication information for a service communication list. Service communication information is collected at a central location. A communication event list is generated from the collected information at the central location. The communication event list may be transmitted to one or more communication devices associated with a user from the central location.

In one aspect, a method for distributing a communication event list is provided. The method may include using a server to centrally collect past, present, and future communication events from two or more communication services; selecting a user; generating a communication events list including communication events for the selected user; transmitting the communication events list to one or more communication devices associated with the user; and displaying the communication events list on the associated communication devices.

In a second aspect, a method for displaying a communication events list is provided. The method includes collecting past, present, and future communication events from two or more communication services; generating a communication events list of past, present, and future communication events; transmitting the communication events list from the server to a communication device; and displaying the communication events list, such that past, present, and future communication events may be viewed on the communication device.

In a third aspect, a system for displaying communication events is provided. The system includes a communication device and a server. The server is operable to combine communication events from two or more services associated with a user into a communication events list. Each communication event is a past, present, and future communication events. The communication events list is transferred to and displayed on the communication device.

In a fourth aspect, computer readable storage media is provided. The computer readable storage media having stored therein data representing instructions executable by a programmed processor. The instructions include collecting past, present, and future communication events from two or more communication services; selecting a user; generating a communication events list including communication events for the selected user; and transmitting the communication events list to one or more communication devices associated with the user.

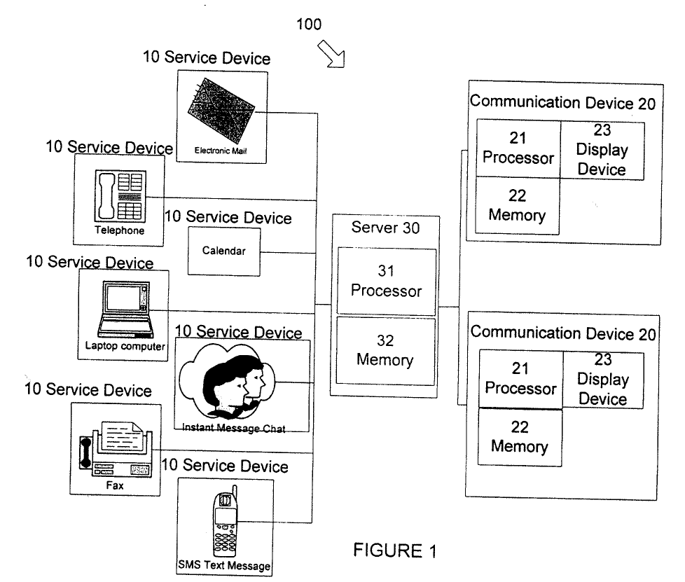

FIG. 1 shows a system 100 including a service device 10, a communication device 20, and a server 30. Additional, different, or fewer components may be provided. For example, the system 100 may include a plurality of service devices 10, communication devices 20, and/or servers 30. The system 100 is a network, communication system, remote terminal system, or any other system for providing communication or service. For example, the system 100 is a network for providing centralized aggregation of service communication event information and centralized distribution of a communication event list.

The service device 10 is an email server, exchange server, information router, PDX device, instant message server, content router, RRS threaded discussion group or any now known or later developed device for providing communication service. The service device 10 provides communication service to the communication device 20. Communication service may include phone service, video messaging service, video conferencing service, conferencing service, electronic mail service, instant message service, SMS, voice mail service, calendar service, any combination thereof, or any now known or later developed communication service.

The service device 10, communication device 20, and server 30 may communicate with each other using a protocol, telephone line, wireless device, wire (cable), any combination thereof, or any other now known or later developed communication technique. The communication may be direct or indirect. For example, the service device 10 may communicate with the communication device 20 through the server 30. In another example, the communication device 20 may communicate directly with the service device 10.

The communication device 20 includes a processor 21, memory 22, and display device 23. Additional, different, or fewer components may be provided. For example, the communication device 20 may include an input device, such as a keyboard, mouse, microphone, or joystick.

The communication device 20 is a workstation, personal computer, laptop computer, personal digital assistant (PDA), remote terminal device, telephone, cellular telephone, handheld device, portable device, camera, music player, or other now known or later developed communication device. The communication device 20 is a device for receiving, transmitting, and managing communication. The communication device 20 may be used for the transmission of signs, signals (including control signals), writing, images and sounds or intelligence of any nature.

The communication device 20 may be associated with a user (e.g., operator), such as being registered to the user, owned by the user, associated with user as rule, operating on the users behalf, and/or generally used by the user. Communication services for a user may be transmitted to associated communication devices 20. For example, a user may be registered for phone and email service. The phone and email service may be sent to some, none, or all of the communication devices 20 associated with the user. In another example, an out of office reply may be associated with the user. The reply may be automatically sent as an association with the user.

The processors are general processors, digital signal processors, application specific integrated circuits, field programmable gate arrays, analog circuits, digital circuits, combinations thereof, or other now known or later developed processors. The processors 21 may be single devices or combinations of devices, such as associated with a network or distributed processing. Any of various processing strategies may be used, such as multi-processing, multi-tasking, parallel processing, remote processing, centralized processing or the like. The processors 21 and 31 are responsive to instructions stored as part of software, hardware, integrated circuits, firmware, micro-code or the like.

The processor 21 is operable to transmit and/or receive communication event information. A communication event is a telephone call, electronic mail message, instant message, short text message, voice message, voice recording, document update, meeting, calendar event, any combination thereof, or any now known or later developed communication event. Additional, different, or fewer communication events may be provided. The event occurs as part of providing the service. For example, a phone service is provided. Each call or message provided using the service is an event.

A past communication event is a communication event that has began and ended. Past communication events are completed before the present time that the communication device is being used. For example, an email that was received during a time period before a user checks the communication device 20 is a past communication event. The log of past communication events may be archived or stored in memory 23 or a record of the past communication event. In another example, a meeting that has already taken place (e.g., ended) is a past communication event. Notification of a future meeting where the notification has been completed is a past communication event.

A present communication event is a communication event that is currently taking place, such as active or pending communication events. A present communication event is an event that has begun, but has not ended. For example, an email that a user is in the process of drafting may be considered a present communication event. After the email is sent, the email may be considered a past communication event. In another example, a meeting that is taking place (e.g., begun, but not ended) may be a present communication event. During the meeting, the meeting is a present communication event because the meeting is active.

A future communication event is an event that is going to take place in the future. A future communication event is an event that has not begun and/or ended. For example, a meeting scheduled in the future (e.g., the next minute, the next hour, the next day, the next year) is a future communication event.

The processor 21 may receive communication from one or more service devices 10 and/or servers 30. For example, the processor 21 may receive an event communication list from the server 30. In another example, the processor 21 may directly receive service from a service device 10.

The processor 21 may communicate with the memory 22. Communicating with the memory 22 may include reading or writing. For example, the processor 21 may retrieve communication event information stored in the memory 22. In another example, the processor 21 may cause the event communication list to be stored in the memory 22. The list may be read from memory 22.

The processor 21 may cause information to be displayed on the display device 22. For example, a communication events list may be displayed. A user may view the list. The processor 21 may retrieve information associated with the list, such as an email message or voice recording.

The display device 23 is a CRT, monitor, flat panel, a general display, LCD, projector, printer or other now known or later developed display device for outputting information. The display device 23 may display one or more images. For example, the display device 23 may display images, projections, or representations of a workspace. In another example, the display device 23 may display 3D images, projections, or representations.

The display device 23 is operable to display information. For example, the processor 31 is operable to cause the communication events list to be displayed on the display device 23.

The memory devices 22 are computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory devices 22 may be single devices or a combination of devices. The memory devices 22 may be adjacent to, part of, networked with and/or remote from the processors 21.

The memory devices 22 may be computer readable storage media having stored therein data representing instructions executable by the programmed processors 21. The instructions may be for displaying or distributing a communication event list. The memory devices 22 store instructions for the processors 21 and 31. The processors 21 are programmed with and execute the instructions. The functions, acts, methods or tasks illustrated in the figures or described herein are performed by the programmed processors 21 executing the instructions stored in the memory devices 22. The functions, acts, methods or tasks are independent of the particular type of instructions set, storage media, processor or processing strategy and may be performed by software, hardware, integrated circuits, firm ware, micro-code and the like, operating alone or in combination. The instructions are for implementing the processes, techniques, methods, or acts described herein.

The memory 22 is operable to store information. The memory 22 may store event information, communication event list information, and communication event database information. Additional, different, or less information may be stored in the memory 22. For example, the processor 31 is operable to cause a communication events list to be stored in memory 22.

The server 30 includes a processor 31 and memory 32. Additional, different, or fewer components may be provided. For example, the server 30 may include an input device, such that manual control may be provided. The server 30 is a workstation, personal computer, central server, network server, remote terminal server, business server, personal server, or other now known or later developed device for aggregating communication event information. In one example, the server 30 provides centralized aggregation of communication event information; centralized generation of a communication event list based on communication event information associated with a user; and centralized distribution of the communication event list. For example, the server 30 may automatically generate a communication event list having all or some of the communication events associated with a user. The server 30 may distribute the communication event list to one or more communication devices associated with the user.

The processor 31 is one or more of the devices discussed above for the processors 21. The processor 31 may be the same or different type of device as the processors 21. Similarly, the memory 32 is one or more of the memories discussed above for the memory 22 of the communications devices 20. The memory 32 may be the same or different type of memory as the memories 22 of the communications devices 20. The memory 32 stores instructions and/or data for use by the processor 31.

The processor 31 collects service communication event information. The communication event information may be associated with a user; communication device 20; service device 10; enterprise; business; employee; or other organization, device, or person. Collection is the process of coming into possession of the service communication event information. As discussed below, collection may include receiving, pulling, requesting, recording, or generating service communication event information. Once collected, the processor 31 may combine, manipulate, organize, or perform other functions on the collected service communication event information. Collection may or may not occur in real time. The server 30 may collect all, some, or none of the associated communication event information

The processor 31 may receive communication event information from a service device 10 or communications device 20. Reception may be automatic, manual, or a combination thereof. The service device 10 may transmit communication event information as part of registration, as a rule, or in response to a request.

The server 30 may be registered with a service device 10 or communications device 20. Registration may require the server 30 to subscribe for service. As a result of the server 30 being registered, the service device 10 or communications device 20 may transmit communication event information. The event information may be transmitted upon the occurrence of another event, when information is transmitted to a communication device 20, periodically, continuously, or as a rule (e.g., established during registration).

The server 30 may be registered with another system. A system including the server 30 and one or more communication devices 20 may be registered with another system (e.g., having a server and communication devices). For example, a first business system may be registered with a second business system. The systems may share information using the registration. For example, registration may limit access to information.

The server 30 may request communication event information from the service device 10 or communications device 20. The request may include user information. In reply to the request, communication event information associated with the user is transmitted to the server 30. As discussed above, the processor 31 may receive the service information.

The processor 31 may pull communication event information. Pulling includes retrieving or extracting service information. Pulling is an active process. For example, the processor 31 may locate and extract service information stored on a service device 10 or communication device 20. The processor 31 may locate service information using a list of locations, a search algorithm, or other technique for locating information. The processor 31 may copy the located service information and return the copy to the server 30.

The processor 31 may monitor one or more service devices 10, communication devices 20, or other communication services. The processor 31 may record or copy the monitored communication event information. For example, communication may be transmitted between two communication devices 20 using a communication processing service, such as a PBX device. The processor 31 may monitor both the endpoints (e.g., the telephones) and/or the communication processing service (e.g., the PBX device). The service information from both the endpoints and the communication processing service may be recorded or copied.

The processor 31 may generate communication event information using an application stored on, loaded on, installed on, or communicated to the server 30. For example, a calendar service may be installed on the server 30 or the communication device 20. The calendar service may store, track, organize, or manage events, such as meetings, reminders, dates, conferences, or other calendar related events. The processor 31 may generate communication event information from a reminder or scheduled meeting stored in the calendar service. Alternatively, the calendar service may be stored on a communication device 20. The communication device 20 may communicate service information to the processor 31 regarding the communication event. Alternatively, the processor 31 may generate communication event information based on monitoring information. In addition, or as an alternative to, to the processor 21 generating communication events, the communication events may be generated by a system, such as a system with a server and communication event.

The communications may be routed through or use the processor 31, so the processor 31 may generate communications event information. The event information is generated as part of operating or providing the communications. The processor 31 collects the event information as separate events or as lists or sub-lists. For example, a list generated by a communications device is received for combination with other lists or event information.

The processor 31 generates a communication events list based on all, some, or none of the collected communication event information. For example, a communication event list may be generated for a selected user. The list may include only communication information associated with the selected user. Generating a communication events list may include combining, aggregating, or grouping service communication event information. The communication event list may or may not be generated in real time.

The communication events list is an integrated list of communication events from one or more services. For example, the communication events list may include communication event history. The communication events list may be used to display the communication events from one or more services on a single screen. A user may use the communication events list to view or manage communication events for each of the services associated with the communication device.

The processor 31 may select a user. The processor 31 is operable to distinguish between users. For example, the processor 31 may identify communication event information associated with a first user, as opposed to communication event information associated with a second user. Alternatively, a user may be selected manually.

The processor 31 is operable to generate a plurality of communication event lists from the collected communication event information. A communication event list may be generated for one or more selected users. For example, a server 30 may be a network server for a business. The business may have three employees. The server 30 may collect communication event information associated with the three employees. A first communication event list may be generated for the first employee using communication event information associated with the first employee. Second and third communication event lists may be generated for the second and third employees, respectively. A list for a plurality of employees or a list aggregating from different lists may be generated.

The processor 31 may transmit a communication event list to one or more communication devices 20. The events list may be transmitted to one or more communication devices 20 associated with a user, such as a selected or identified user. For example, a user may be associated with a plurality of communication devices, such as a computer and a PDA. The event list generated for the user may be transmitted to the associated communication devices. Event lists for other users may be transmitted to a different user, such as for supervising communications.

The processor 31 may transmit a plurality of communication event lists to a plurality of associated users. For example, a network server may transmit a first communication event list to one or more communication devices associated with a first employee. The network server may transmit second and third communication event lists to one or more communication devices associated with the second and third employees. The lists may be transmitted to other devices, such as a database for storage or a processor (e.g., computer or workstation) for analysis.

The communication events list may be organized or unorganized. For example, the processor 31 may collect the communication event information and generate a communication event list. The processor 21 may organize the communication event list according to a preference.

The communication events list may include past, present, and/or future communication event information. Communication event information may include an event description, representation, illustration, or any combination thereof.

The communication events list may include labels. The labels may be used to organize or manage descriptions of the communication events. The labels may be interactive. For example, the labels may be changed, altered, deleted, or amended. The labels may be used to describe aspects or characteristics of the descriptions. The labels are used to organize according to type, name, subject, date, duration, location, and status of the communication event. Additional, different, or fewer labels may be provided. The labels may be graphical or textual.

The communication event list may or may not have a textual or other description for each communication event under the one or more labels. The description may be graphical or textual and may indicate whether the communication was received or transmitted. For example, the type of communication event may include a graphic, such as a telephone, that describes the service provided and a representation of whether the telephone call was initiated or received.

The communication events list may include links associated with a communication event. The links may be a pathway to a document, location, space, or communication. The link may be used to access a service. For example, a communication event may be a telephonic conference or web meeting. The communication events list may include a pathway to a telephonic meeting place or web meeting place. The link allows the user to join the meeting from the list itself when the meeting becomes active. In another example, a communication event may be an email message with an attached document. The communication events list may include a link to the attached document or the email message. In another example, the link may be a pathway for making a Voice over Internet Protocol (VoIP) call. By following the link, a VoIP call may be made.

The communication event list may include a user input description, such as a note or remark. A note or remark may be a description about a communication event or characteristic related to the communication event. For example, the note or remark may provide a detail or description about the associated communication event. The user's description may be manually input, automatically input, changed, amended or a combination thereof.

The processor 31 may update the communication events list. Updating the communication events list may include integrating communication event information into the communication events list. Integration may occur automatically or manually. For example, received communication event information may be integrated into a communication events list. In another example, the processor 31 may update the communication events list to reflect generated communication events, such as future communication events. The update may add events or alter already listed events.

The processor 21 and 31 are operable to organize the communication events list. Organizing the communication events list may include arranging, sorting, or grouping. Additional, different, or fewer organizational techniques may be used.

The processors 21 and 31 may arrange the communication event list. Arranging may include putting the communication events into order or into a suitable sequence, relationship, or adjustment. The communication events may be arranged according to date, name of the person the communication event was received from or sent to, duration, location, and/or any other category. For example, the communication event list may be arranged in chronological order.

The processors 21 and 31 may group communication events in a communication events list. The communication events may be grouped according to type, name, subject, date, duration, location, status, notes, any combination thereof, or any now known or later developed grouping technique. A display device may take advantage of the groupings and use tabs that may be used to view the different groupings of communication events. The communication events may be grouped as past communication events, present communication events, and future communication events. Tabs may be used for past, present, and future communication events.

The processors 21 and 31 are operable to search the communication events list. Searching may include searching for text or a graphic. The processors 21 and 31 may search for text or a graphic within the communication event list. The processor 31 may use any search algorithm to locate an input value in the communication event list. The processors 21 and 31 may use a lexical, list, graph, tree, or string search algorithm.

The processors 21 and 31 may search within the descriptions under each label, within the documents or links associated with the communication event, within a note or remark, or anywhere else related to the communication event list. Searching may include matching. Keywords may be matched. For example, a note associated with a telephone call may include a description of the subjects discussed during the telephone call. The processors 21 and 31 may search the remarks of the subjects discussed for a match of a keyword. In another example, the processors 21 and 31 may search for a communication event received on a certain date or from a certain user.

The processors 21 and 31 are operable to cause a communication event list to be displayed on the display device 22. The displayed communication event list may include descriptions of one or more past, present, and/or future communication events.

The processors 21 and 31 may allow a user to scroll through the communication event list. Scrolling may include scrolling to view future communication events, scrolling to view past communication events, and scrolling to view present communication events. For example, if present communication events are being displayed, the processors 21 and 31 may be instructed to display the portion of the communication events list that describes future communication events.

The processors 21 and 31 may generate a timetable. The timetable may be based upon all, some, or none of the communication event information used to determine the communication event list. A timetable is a schedule showing a planned order or sequence of the communication events. For example, the processors 21 and 31 may generate a timetable that sets out in tabular form the time at which the communication events are planned to take place, will take place, or did take place. The timetable may include the information, documents, links, and notes that are provided in the communication event list.

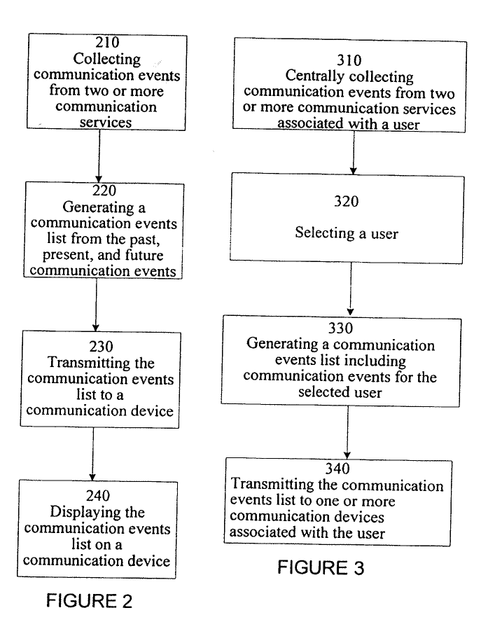

FIG. 2 shows a method for displaying a communication events list. The method is implemented using the system 100 of FIG. 1 or a different system. The acts may be performed in the order shown or a different order. The acts may be performed automatically, manually, or the combination thereof.

The method may include collecting past, present, and future communication events from two or more communication services [act 210]; generating a communication events list from the past, present, and future communication events [act 220]; transmitting the communication events list to a communication device [act 230]; and displaying the communication events list, such that past, present, and future communication events may be viewed on the communication device [act 240].

In act 210, a server collects past, present, and/or future communication events from one or more communication services. The server may actively collect communication event information; passively collect communication event information; or the combination thereof.

Active collection includes pulling, requesting, generating, or monitoring communication events or event information. The server may pull communication event information from a service device. Pulling includes retrieving or extracting service information. For example, the server may locate and extract service information stored on a service device or communication device.

The server may request communication event information from a service device or communication device. The request may be associated with a user or communication device. In reply to the request, communication event information associated with the user or communication device may be transmitted to and received by the server.

The server may generate communication event information. The server may generate communication events from applications stored on, loaded on, installed on, or communicated to the server. For example, a calendar service may be installed on the server or communication device. The calendar service may store, track, organize, or manage events, such as meetings, reminders, dates, conferences, or other calendar related events. The server may generate communication event information from a reminder or scheduled meeting stored in the calendar service.

The server may monitor one or more service devices, communication devices, or other communication services. The processor may record, copy, or generate communication event information based on the monitored service. For example, communication may be transmitted between two communication devices 20 using a communication processing service, such as a PBX device. The processor 31 may monitor both the endpoints and the communication processing service. The communication event information from the endpoints and/or the communication processing service may be recorded or copied. Alternatively, the server may generate communication event information based on the monitoring of the endpoints and/or the communication processing service.

Passive collection includes receiving communication event information as part of being registered to receive such information. The server may be registered with one or more service devices and/or communications devices. Registration may require the server to automatically or manually subscribe to receive communication event information. As a result of the server being registered, the service device may transmit communication event information. The event information may be transmitted upon the occurrence of another event, when information is transmitted to a communication device 20, periodically, continuously, or as a rule (e.g., established during registration). The server may receive the transmitted information.

In act 220, the server generates a communication events list from the past, present, and/or future communication events. Generating the communication event list may include combining or aggregating the collected communication events into a single list. The communication event list may include communication events associated with a user. The communication event list may include communication events from all or some of the services associated with the user. For example, the communication event list may include phone service events, email service events, and SMS text message events associated with a single user.

In act 230, the server transmits the communication events list to a communication device. The communication device may be the primary or other device used by the user. Alternatively, the server may transmit the communication events list to one or more communication devices associated with the user.

In act 240, the communication device displays the communication events list, such that past, present, and future communication events may be viewed on the communication device.

FIG. 3 shows a method for distributing a communication events list. The method is implemented using the system 100 of FIG. 1 or a different system. The acts may be performed in the order shown or a different order. For example, act 310 and act 320 may be performed in reverse order. The acts may be performed automatically, manually, or the combination thereof.

The method may include collecting past, present, and/or future communication events from two or more communication services [act 310]; selecting a user [act 320]; generating a communication events list based on the selected user [act 330]; and transmitting the communication events list to one or more communication devices associated with the selected user [act 340].

In act 310, collecting may include pulling, receiving, requesting, or generating communication events. All, some, or none of the past, present, and future communication events associated with the selected user may be collected.

In act 320, one or more users may be selected.

In act 330, generating may include combining the communication events associated with the selected user into the communication events list. The server may generate a plurality of communication event lists from the collected communication event information. A communication event list may be generated for one or more selected users. For example, a server may be a network server for a business. A communication event list may be generated for each of the employees. A list for a plurality of employees or a list aggregating from different lists may be generated.

In act 340, transmitting may include transmitting the communication events list to one or more communication devices associated with the user. The server may transmit a communication event list to one or more communication devices. The events list may be transmitted to one or more communication devices associated with a user, such as a selected or identified user. For example, a user may be associated with a plurality of communication devices, such as a computer and a PDA. The event list generated for the user may be transmitted to the associated communication devices. Event lists for other users may be transmitted to a different user, such as for supervising communications.

The server may transmit a plurality of communication event lists to a plurality of associated users. For example, a network server may transmit a first communication event list to one or more communication devices associated with a first employee. The network server may transmit second and third communication event lists to one or more communication devices associated with the second and third employees. The lists may be transmitted to other devices, such as a database for storage or a processor (e.g., computer or workstation) for analysis.

It is beneficial to use a server to transmit communication event lists to one or more communication devices because it reduces the transmission across the network, reduces the amount of processing that occurs, and allows for centralized updating.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for displaying a communication events list, the method comprising:
collecting communication events from one or more communication services, where collecting is performed with a server;
generating a communication events list of communication events, where generating is performed with the server;
transmitting the communication events list from the server to a communication device; and
displaying the communication events list, such that communication events are viewed on the communication device.

2. The method as claimed in claim 1, wherein collecting communication events includes collecting communication events associated with a selected user.

3. The method as claimed in claim 2, wherein transmitting the communication events list includes transmitting the communication events list to a plurality of communication devices associated with the user.

4. The method as claimed in claim 1, wherein collecting communication events includes the server receiving, pulling, or generating communication event information.

5. The method as claimed in claim 1, comprising updating the communication event list with the server.

6. The method as claimed in claim 1, wherein collecting communication events includes registering the server with a service device.

7. The method as claimed in claim 6, wherein collecting communication events includes receiving communication event information from the service device, as part of a registration.

8. The method as claimed in claim 1, wherein the communication events include past, present, and future communication events.

9. The method as claimed in claim 1, wherein collecting communication events includes collecting from two or more communication services.

10. A system for displaying communication events, the communication system comprising:
a communication device;
a server operable to combine communication events from one or more services into a communication events list;
wherein the communication events list is transferred to and displayed on the communication device.

11. The system as claimed in claim 10, wherein the one or more services comprises two or more services associated with a user.

12. The system as claimed in claim 1 1, wherein the server is operable to transmit the communication events list to a plurality of communication devices associated with the user.

13. The system as claimed in claim 10, wherein the server actively or passively collects communication events from two or more services.

14. The system as claimed in claim 13, wherein active collection includes pulling, requesting, or generating communication event information.

15. The system as claimed in claim 13, wherein passive collection includes automatically receiving communication event information as part of being registered to receive such information.

16. The system as claimed in claim 15, wherein the server is registered with one or more service devices or other systems.

17. The system as claimed in claim 10, wherein the communication events list may be used to access the one or more services.

18. Computer readable storage media with instructions for transmitting a communication event list to a communication device, the instructions including:
collecting communication events from one or more communication services;
selecting a user;
generating a communication events list based on the selected user; and
transmitting the communication events list to one or more communication devices associated with the selected user.

19. The instructions as claimed in claim 18, wherein collecting includes pulling, receiving, requesting, or generating communication events.

20. The instructions as claimed in claim 18, wherein collecting includes collecting all of the past, present, and future communication events associated with the selected user.

21. The instructions as claimed in claim 20, wherein generating includes combining the communication events associated with the selected user into the communication events list.

22. The instructions as claimed in claim 20, wherein transmitting includes transmitting the communication events list to a plurality of communication devices associated with the user.
